(19) United States
(12) Patent Application Publication
(10) Pub. No.: US 2019/0014089 A1
(43) Pub. Date: Jan. 10, 2019

(54) Data Security Protection Method and Apparatus

(71) Applicant: Huawei Technologies Co., Ltd., Shenzhen (CN)

(72) Inventor: Xinpeng Wei, Shenzhen (CN)

(21) Appl. No.: 16/110,505

(22) Filed: Aug. 23, 2018

Related U.S. Application Data
(63) Continuation of application No. PCT/CN2016/074482, filed on Feb. 24, 2016.

(51) Int. Cl. H04L 29/06; G06F 21/64

(52) U.S. Cl. CPC H04L 63/0428; H04W 12/10; G06F 21/645

(57) ABSTRACT

Embodiments of the present application disclose a data security protection method and an apparatus. The method includes: receiving a target message used to carry target data, the target message includes an unencrypted area and an integrity protection encryption area, the unencrypted area is used to carry data that does not need to be encrypted, the data that does not need to be encrypted is data in the target data or data related to the target data, the integrity protection encryption area is used to carry data that needs integrity protection and encryption, and the data that needs integrity protection and encryption is data in the target data; performing service processing on the target message based on the data carried in the unencrypted area in the target message; and sending, by the network side device to the second device, a target message obtained after the service processing.

### CROSS-REFERENCE TO RELATED APPLICATIONS

This application is a continuation of International Application No. PCT/CN2016/074482, filed on Feb. 24, 2016, the disclosure of which is hereby incorporated by reference in its entirety.

### TECHNICAL FIELD

The present application relates to the field of data security, and in particular, to a data security protection method and an apparatus.

### BACKGROUND

In today's society, various aspects of people's life are inseparable from a network, and a personal online banking account, a shopping website, an interest website, and the like can be visited by using the network. To protect user privacy, when visiting these websites, a user usually uses a security protocol such as the Secure Sockets Layer (SSL), the Transport Layer Security (TLS), and the Internet Protocol Security (IPSec) to establish a secure channel between both communication parties. The secure channel provides encryption and integrity protection for all data transmitted between both communication parties, to prevent leakage of user information.

An existing security protocol performs encryption processing on all content (which includes service content information, protocol control information, and the like that are accessed by the user) transmitted by both communication parties, and this security protection manner is actually an over-encryption manner (encryption is performed on all transmitted information, regardless of whether the information really needs to be encrypted). Consequently, various network service performance optimization or deep packet inspection (DPI) devices deployed in an operator network cannot process a service due to failure to perceive the transmitted content.

### SUMMARY

Embodiments of the present application provide a data security protection method and an apparatus, so as to prevent a network side device deployed in an operator network from being inoperative.

The following technical solutions are used in the embodiments of the present application to achieve the foregoing objective.

According to a first aspect, a data security protection method is provided. The method includes receiving, by a network side device, a target message that carries target data and that is sent by a first device, where the target data is data transmitted by the first device to a second device, the target message includes an unencrypted area and an integrity protection encryption area, the unencrypted area is used to carry data that does not need to be encrypted, the data that does not need to be encrypted is data in the target data or data related to the target data, the integrity protection encryption area is used to carry data that needs integrity protection and encryption, and the data that needs integrity protection and encryption is data in the target data. The method also includes performing, by the network side device, service processing on the target message based on the data carried in the unencrypted area in the target message. The method also includes sending, by the network side device to the second device, a target message obtained after the service processing.

Optionally, the unencrypted area includes an unprotected area and an integrity protection unencrypted area, the unprotected area is used to carry data that does not need integrity protection and does not need to be encrypted, and the integrity protection unencrypted area is used to carry data that needs integrity protection but does not need to be encrypted.

The data on which integrity protection has been performed in the target message is data on which integrity protection is performed using a first security parameter negotiated between the first device and the second device. The data on which encryption has been performed in the target message is data on which encryption is performed by using a second security parameter negotiated between the first device and the second device.

Optionally, after the performing, by the network side device, service processing on the target message based on the data carried in the unencrypted area in the target message, the method further includes: adding, by the network side device to the unprotected area in the target message, a processing result of performing the service processing on the target message based on the data carried in the unencrypted area in the target message. The sending, by the network side device to the second device, a target message obtained after the service processing includes: sending, by the network side device to the second device, the target message that carries the processing result.

Optionally, the performing, by the network side device, service processing on the target message based on the data carried in the unencrypted area in the target message includes: obtaining, by the network side device, the data carried in the unencrypted area; and performing, by the network side device, service optimization on the target message based on the data carried in the unencrypted area.

Optionally, the target data is carried in the integrity protection encryption area, the data that needs integrity protection but does not need to be encrypted in the target data is carried in the integrity protection unencrypted area, and the data that does not need integrity protection and does not need to be encrypted in the target data is carried in the unprotected area; or the target data is carried in the integrity protection encryption area, and metadata of the target data is carried in the unencrypted area; or the data that needs integrity protection and needs to be encrypted in the target data is carried in the integrity protection encryption area, the data that needs integrity protection but does not need to be encrypted in the target data is carried in the integrity protection unencrypted area, and the data that does not need integrity protection and does not need to be encrypted in the target data is carried in the unprotected area.

According to a second aspect, a data security protection method is provided. The method includes determining, by a first device, a target message carrying target data, where the target data is data transmitted by the first device to a second device, the target message includes an unencrypted area and an integrity protection encryption area, the unencrypted area is used to carry data that does not need to be encrypted, the data that does not need to be encrypted is data in the target data or data related to the target data, the integrity protection encryption area is used to carry data that needs integrity protection and encryption, and the data that needs integrity protection and encryption is data in the target data. The method also includes sending, by the first device, the target message to a network side device, so that the network side device performs service processing on the target message based on the data carried in the unencrypted area in the target message.

Optionally, the unencrypted area includes an unprotected area and an integrity protection unencrypted area, the unprotected area is used to carry data that does not need integrity protection and does not need to be encrypted, and the integrity protection unencrypted area is used to carry data that needs integrity protection but does not need to be encrypted.

The data on which integrity protection has been performed in the target message is data on which integrity protection is performed by using a first security parameter negotiated between the first device and the second device. The data on which encryption has been performed in the target message is data on which encryption is performed by using a second security parameter negotiated between the first device and the second device.

Optionally, the determining, by a first device, a target message includes: adding, by the first device, the target data to the integrity protection encryption area, adding, to the integrity protection unencrypted area, the data that needs integrity protection but does not need to be encrypted in the target data, and adding, to the unprotected area, the data that does not need integrity protection and does not need to be encrypted in the target data; or adding, by the first device, the target data to the integrity protection encryption area, and adding metadata of the target data to the unencrypted area; or adding, by the first device to the integrity protection encryption area, the data that needs integrity protection and needs to be encrypted in the target data, adding, to the integrity protection unencrypted area, the data that needs integrity protection but does not need to be encrypted in the target data, and adding, to the unprotected area, the data that does not need integrity protection and does not need to be encrypted in the target data.

According to a third aspect, a network side device is provided. The device includes a receiving unit, configured to receive a target message that carries target data and that is sent by a first device, where the target data is data transmitted by the first device to a second device, the target message includes an unencrypted area and an integrity protection encryption area, the unencrypted area is used to carry data that does not need to be encrypted, the data that does not need to be encrypted is data in the target data or data related to the target data, the integrity protection encryption area is used to carry data that needs integrity protection and encryption, and the data that needs integrity protection and encryption is data in the target data. The device also includes a processing unit, configured to perform service processing on the target message based on the data carried in the unencrypted area in the target message. The device also includes a sending unit, configured to send, to the second device, a target message obtained after the service processing.

Optionally, the unencrypted area includes an unprotected area and an integrity protection unencrypted area, the unprotected area is used to carry data that does not need integrity protection and does not need to be encrypted, and the integrity protection unencrypted area is used to carry data that needs integrity protection but does not need to be encrypted.

The data on which integrity protection has been performed in the target message is data on which integrity protection is performed by using a first security parameter negotiated between the first device and the second device. The data on which encryption has been performed in the target message is data on which encryption is performed by using a second security parameter negotiated between the first device and the second device.

Optionally, the network side device further includes: a bearing unit, configured to add, to the unprotected area in the target message, a processing result of performing the service processing on the target message based on the data carried in the unencrypted area in the target message. The sending unit is specifically configured to send, to the second device, the target message that carries the processing result.

Optionally, the processing unit is specifically configured to: obtain the data carried in the unencrypted area; and perform service optimization on the target message based on the data carried in the unencrypted area.

Optionally, the target data is carried in the integrity protection encryption area, the data that needs integrity protection but does not need to be encrypted in the target data is carried in the integrity protection unencrypted area, and the data that does not need integrity protection and does not need to be encrypted in the target data is carried in the unprotected area; or the target data is carried in the integrity protection encryption area, and metadata of the target data is carried in the unencrypted area; or the data that needs integrity protection and needs to be encrypted in the target data is carried in the integrity protection encryption area, the data that needs integrity protection but does not need to be encrypted in the target data is carried in the integrity protection unencrypted area, and the data that does not need integrity protection and does not need to be encrypted in the target data is carried in the unprotected area.

According to a fourth aspect, a first device is provided. The first device includes a determining unit, configured to determine a target message carrying target data, where the target data is data transmitted by the first device to a second device, the target message includes an unencrypted area and an integrity protection encryption area, the unencrypted area is used to carry data that does not need to be encrypted, the data that does not need to be encrypted is data in the target data or data related to the target data, the integrity protection encryption area is used to carry data that needs integrity protection and encryption, and the data that needs integrity protection and encryption is data in the target data. The first device also includes a sending unit, configured to send the target message to a network side device, so that the network side device performs service processing on the target message based on the data carried in the unencrypted area in the target message.

Optionally, the unencrypted area includes an unprotected area and an integrity protection unencrypted area, the unprotected area is used to carry data that does not need integrity protection and does not need to be encrypted, and the integrity protection unencrypted area is used to carry data that needs integrity protection but does not need to be encrypted.

The data on which integrity protection has been performed in the target message is data on which integrity protection is performed by using a first security parameter negotiated between the first device and the second device. The data on which encryption has been performed in the target message is data on which encryption is performed by using a second security parameter negotiated between the first device and the second device.

Optionally, the determining unit is specifically configured to: add the target data to the integrity protection encryption area, add, to the integrity protection unencrypted area, the data that needs integrity protection but does not need to be encrypted in the target data, and add, to the unprotected area, the data that does not need integrity protection and does not need to be encrypted in the target data; or add the target data to the integrity protection encryption area, and add metadata of the target data to the unencrypted area; or add, to the integrity protection encryption area, the data that needs integrity protection and needs to be encrypted in the target data, add, to the integrity protection unencrypted area, the data that needs integrity protection but does not need to be encrypted in the target data, and add, to the unprotected area, the data that does not need integrity protection and does not need to be encrypted in the target data.

According to a fifth aspect, a network side device is provided, including a receiver, a memory, a processor, and a transmitter. The receiver is configured to receive a target message that carries target data and that is sent by a first device, where the target data is data transmitted by the first device to a second device, the target message includes an unencrypted area and an integrity protection encryption area, the unencrypted area is used to carry data that does not need to be encrypted, the data that does not need to be encrypted is data in the target data or data related to the target data, the integrity protection encryption area is used to carry data that needs integrity protection and encryption, and the data that needs integrity protection and encryption is data in the target data. The memory is configured to store a group of code, and the processor performs the following action based on the group of code: performing service processing on the target message based on the data carried in the unencrypted area in the target message. The transmitter is configured to send, to the second device, a target message obtained after the service processing.

Optionally, the unencrypted area includes an unprotected area and an integrity protection unencrypted area, the unprotected area is used to carry data that does not need integrity protection and does not need to be encrypted, and the integrity protection unencrypted area is used to carry data that needs integrity protection but does not need to be encrypted.

The data on which integrity protection has been performed in the target message is data on which integrity protection is performed using a first security parameter negotiated between the first device and the second device. The data on which encryption has been performed in the target message is data on which encryption is performed by using a second security parameter negotiated between the first device and the second device.

Optionally, the processor is further configured to: add, to the unprotected area in the target message, a processing result of performing the service processing on the target message based on the data carried in the unencrypted area in the target message. The transmitter is specifically configured to send, to the second device, the target message that carries the processing result.

Optionally, the processor is specifically configured to: obtain the data carried in the unencrypted area; and perform service optimization on the target message based on the data carried in the unencrypted area.

Optionally, the target data is carried in the integrity protection encryption area, the data that needs integrity protection but does not need to be encrypted in the target data is carried in the integrity protection unencrypted area, and the data that does not need integrity protection and does not need to be encrypted in the target data is carried in the unprotected area; or the target data is carried in the integrity protection encryption area, and metadata of the target data is carried in the unencrypted area; or the data that needs integrity protection and needs to be encrypted in the target data is carried in the integrity protection encryption area, the data that needs integrity protection but does not need to be encrypted in the target data is carried in the integrity protection unencrypted area, and the data that does not need integrity protection and does not need to be encrypted in the target data is carried in the unprotected area.

According to a sixth aspect, a first device is provided, including a memory, a processor, and a transmitter. The memory is configured to store a group of code, and the processor performs the following action based on the group of code: determining a target message carrying target data, where the target data is data transmitted by the first device to a second device, the target message includes an unencrypted area and an integrity protection encryption area, the unencrypted area is used to carry data that does not need to be encrypted, the data that does not need to be encrypted is data in the target data or data related to the target data, the integrity protection encryption area is used to carry data that needs integrity protection and encryption, and the data that needs integrity protection and encryption is data in the target data. The transmitter is configured to send the target message to a network side device, so that the network side device performs service processing on the target message based on the data carried in the unencrypted area in the target message.

Optionally, the unencrypted area includes an unprotected area and an integrity protection unencrypted area, the unprotected area is used to carry data that does not need integrity protection and does not need to be encrypted, and the integrity protection unencrypted area is used to carry data that needs integrity protection but does not need to be encrypted.

The data on which integrity protection has been performed in the target message is data on which integrity protection is performed by using a first security parameter negotiated between the first device and the second device. The data on which encryption has been performed in the target message is data on which encryption is performed by using a second security parameter negotiated between the first device and the second device.

Optionally, the processor is specifically configured to: add the target data to the integrity protection encryption area, add, to the integrity protection unencrypted area, the data that needs integrity protection but does not need to be encrypted in the target data, and add, to the unprotected area, the data that does not need integrity protection and does not need to be encrypted in the target data; or add the target data to the integrity protection encryption area, and add metadata of the target data to the unencrypted area; or add, to the integrity protection encryption area, the data that needs integrity protection and needs to be encrypted in the target data, add, to the integrity protection unencrypted area, the data that needs integrity protection but does not need to be encrypted in the target data, and add, to the unprotected area, the data that does not need integrity protection and does not need to be encrypted in the target data.

According to the method and the apparatus provided in the embodiments of the present application, the first device may add the data that does not need to be encrypted to the unencrypted area in the target message and send the data that does not need to be encrypted to the network side device, and the network side device may obtain the data in the unencrypted area, and perform the service processing on the target message based on the data in the unencrypted area, so as to prevent the network side device deployed in the operator network from being inoperative.

### BRIEF DESCRIPTION OF THE DRAWINGS

To describe the technical solutions in the embodiments of the present application or in the prior art more clearly, the following briefly describes the accompanying drawings required for describing the embodiments or the prior art. Apparently, the accompanying drawings in the following description show merely some embodiments of the present application, and a person of ordinary skill in the art may still derive other drawings from these accompanying drawings without creative efforts.

FIG. 1 is a schematic diagram of communication between a first device and a second device in a current system;

FIG. 2 is a flowchart of a data security protection method according to an embodiment of the present application;

FIG. 3 is a schematic diagram of composition of a target message according to an embodiment of the present application;

FIG. 4 is a schematic diagram of carrying data in a target message according to an embodiment of the present application;

FIG. 5 is a schematic diagram of carrying data in another target message according to an embodiment of the present application;

FIG. 6 is a schematic diagram of carrying data by using the TLS Record Protocol in the prior art;

FIG. 7 is a schematic diagram of communication between a first device and a second device according to an embodiment of the present application;

FIG. 8 is a schematic diagram of composition of a network side device according to an embodiment of the present application;

FIG. 9 is a schematic diagram of composition of another network side device according to an embodiment of the present application;

FIG. 10 is a schematic diagram of composition of another network side device according to an embodiment of the present application;

FIG. 11 is a schematic diagram of composition of a first device according to an embodiment of the present application; and

FIG. 12 is a schematic diagram of composition of another first device according to an embodiment of the present application.

### DETAILED DESCRIPTION OF ILLUSTRATIVE EMBODIMENTS

The following describes the technical solutions in the embodiments of the present application with reference to the accompanying drawings in the embodiments of the present application. Apparently, the described embodiments are merely some but not all of the embodiments of the present application. All other embodiments obtained by a person of ordinary skill in the art based on the embodiments of the present application without creative efforts shall fall within the protection scope of the present application.

To enable a person skilled in the art to understand the technical solutions provided in the embodiments of the present application more clearly, a current system related to this application is briefly described.

1. Data Encryption

A basic idea of the data encryption is to change data that needs to be protected into some irregular data by replacing and converting the data that needs to be protected, to disguise the data that needs to be protected, so that a third party cannot learn of content of the protected data. In this process, the data that needs to be protected is referred to as a plaintext, an algorithm for replacing and converting is referred to as an encryption algorithm, a result of the plaintext after replacement and conversion is referred to as a ciphertext, and a process of generating the ciphertext from the plaintext is referred to as encryption. Decryption is a process opposite to the encryption, and converts the ciphertext into the plaintext. Operations of the encryption algorithm and a decryption algorithm are usually performed under control of a set of keys, which are respectively referred to as an encryption key and a decryption key.

2. Data Integrity Protection

Integrity protection is a method for performing security protection on data, and a function of the integrity protection is mainly to ensure that the data is not modified by a third party in a process of transmission between both communication parties. If the data on which integrity protection is performed is tampered with by the third party, a receive end of the data may detect that the data is tampered with by the third party when receiving the data. In this case, the receive end usually directly discards the received data.

It should be noted that the data on which integrity protection is performed is visible to the third party. In other words, the third party may read the data on which integrity protection is performed.

Generally, a transmit end generates a message digest of the data using an integrity protection key that is negotiated with the receive end and the data that is sent to the receive end, and then transmits the message digest together with the data. After receiving the data and the message digest, the receive end uses the same method as the transmit end to calculate a message digest. If the message digest obtained by calculation is the same as the received message digest, it is considered that the data is not tampered with. If the message digest obtained by calculation is different from the received message digest, it is considered that the data has been tampered with.

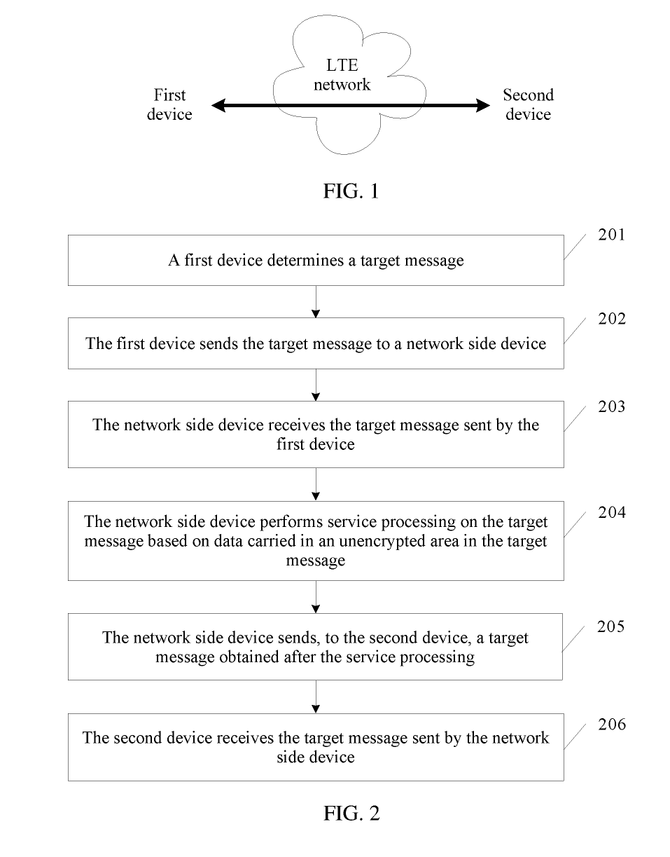

The method provided in this embodiment of the present application may be applied to a network system such as CDMA2000 (Code Division Multiple Access 2000), Wideband Code Division Multiple Access (W-CDMA), Time Division-Synchronous Code Division Multiple Access (TD-SCDMA), Long Term Evolution (LTE), and LTE-advanced. An LTE network is used as an example. As shown in FIG. 1, a first device communicates with a second device by using the LTE network, the first device may be a terminal device (such as a mobile phone, a tablet computer, and a notebook computer), and the second device may be a network server (namely, a host running server software, for example, a server of Sina, and a server of Baidu). Alternatively, the first device may be the network server, the second device may be the terminal device, and a network side device in this embodiment of the present application is a device in the network system.

An embodiment of the present application provides a data security protection method. As shown in FIG. 2, the method includes the following steps.

201. A first device determines a target message.

The target message is used to carry target data, the target data is data transmitted by the first device to a second device, the target message includes an unencrypted area and an integrity protection encryption area, the unencrypted area is used to carry data that does not need to be encrypted, the data that does not need to be encrypted is data in the target data or data related to the target data, the integrity protection encryption area is used to carry data that needs integrity protection and encryption, and the data that needs integrity protection and encryption is data in the target data.

Optionally, the unencrypted area includes an unprotected area and an integrity protection unencrypted area, the unprotected area is used to carry data that does not need integrity protection and does not need to be encrypted, and the integrity protection unencrypted area is used to carry data that needs integrity protection but does not need to be encrypted.

Because the unencrypted area is used to carry the data that does not need to be encrypted, the data carried in the unencrypted area is unencrypted data. Because the integrity protection encryption area is used to carry the data that needs integrity protection and encryption, the data carried in the integrity protection encryption area is data on which integrity protection and encryption have been performed, and the data carried in the integrity protection encryption area is invisible to a device except the first device and the second device. Specifically, the data carried in the unprotected area is the data on which integrity protection and encryption are not performed, the device except the first device and the second device may obtain or modify the data carried in the unprotected area, or may add data to the unprotected area (when adding the data to the unprotected area, the device except the first device and the second device may also use a security parameter negotiated with the first device or the second device to perform security protection on the added data). The data carried in the integrity protection unencrypted area is the data on which integrity protection has been performed but the encryption is not performed, the device except the first device and the second device may obtain the data carried in the integrity protection unencrypted area, but cannot modify the data carried in the integrity protection unencrypted area, or cannot add data to the integrity protection unencrypted area.

Generally, specific content of a service in the target message needs integrity protection and encryption, content that is allowed to be read by a third party but is not allowed to be modified by the third party in the target message needs integrity protection but does not need to be encrypted, and content that is allowed to be read by the third party and is allowed to be modified by the third party in the target message does not need integrity protection and does not need to be encrypted.

It should be noted that the data on which integrity protection has been performed in the target message is data on which integrity protection is performed using a first security parameter negotiated between the first device and the second device. The data on which encryption has been performed in the target message is data on which encryption is performed using a second security parameter negotiated between the first device and the second device. To be specific, the data carried in the unprotected area is data on which encryption and the integrity protection are not performed by using a security parameter negotiated by both communication parties. The data carried in the integrity protection unencrypted area is data on which integrity protection is performed by using the first security parameter negotiated by both communication parties but the encryption is not performed. The data carried in the integrity protection encryption area is data on which integrity protection and encryption are performed by using the first security parameter and the second security parameter that are negotiated by both communication parties.

It should be noted that, security protection may be performed on the data in the unprotected area by using a security parameter negotiated between a network side device and a network server (or a terminal device). For example, a message transmitted between the network server and the terminal device may pass through networks of a plurality of operators. However, the network server only wants to allow a network side device in a particular (or some) network operator A that has a contractual relationship with the network server to be capable of reading information in the unprotected area. Then, the network server may encrypt the data in the unprotected area by using the security parameter negotiated between the network server and the network side device of the network operator A. It should be noted that in this case, when the data in the unprotected area is the data in the target data and the data in the unprotected area is not redundantly carried in the integrity protection encryption area or the integrity protection unencrypted area, the terminal device also needs to be capable of decrypting the data in the unprotected area, so as to obtain the data in the unprotected area. Alternatively, when the network side device of the network operator needs to add information to the unprotected area, the added information is accepted by the network server only when the added information is signed.

Similarly, for the integrity protection unencrypted area, the network server or the terminal device may also perform the encryption by using a security parameter negotiated with the network side device, so as to allow, to read information in the integrity protection unencrypted area in the message, a particular (or some) operator network through which the message transmitted between both communication parties passes.

For example, when the target message is a Hypertext Transfer Protocol (HTTP) message that transmits video data, data carried in an unprotected area of the HTTP message may be data that indicates a service type transmitted in the HTTP message (which is a “video” type herein), data carried in an integrity protection unencrypted area may be a video bit rate, and data carried in an integrity protection encryption area may be specific video content. This is merely an example description of the target message herein, and does not limit the target message. Specifically, when the target data is different, data carried in the unprotected area, data carried in the integrity protection unencrypted area, and data carried in the integrity protection encryption area may also be different.

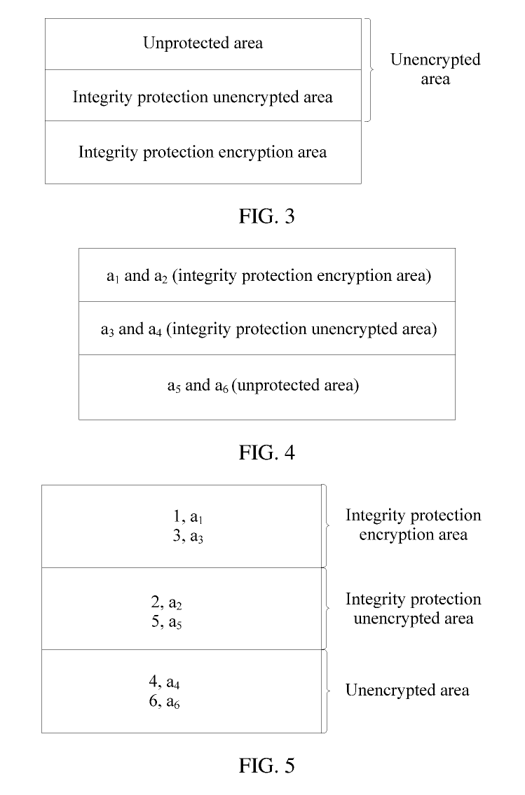

For example, composition of the target message in this embodiment of the present application may be shown in FIG. 3.

Optionally, in a specific implementation, step 201 may be implemented in any one of the following three manners.

In a first manner, the first device adds the target data to the integrity protection encryption area, adds, to the integrity protection unencrypted area, the data that needs integrity protection but does not need to be encrypted in the target data, and adds, to the unprotected area, the data that does not need integrity protection and does not need to be encrypted in the target data.

In a second manner, the first device adds the target data to the integrity protection encryption area, and adds metadata of the target data to the unencrypted area.

The metadata of the target data is data used to describe the target data.

In a third manner, the first device adds, to the integrity protection encryption area, the data that needs integrity protection and needs to be encrypted in the target data, adds, to the integrity protection unencrypted area, the data that needs integrity protection but does not need to be encrypted in the target data, and adds, to the unprotected area, the data that does not need integrity protection and does not need to be encrypted in the target data.

For example, if the target data includes a₁, a₂, a₃, and a₄, where a₁ is the data that does not need integrity protection and does not need to be encrypted in the target data, a₂ is the data that needs integrity protection but does not need to be encrypted in the target data, a₃ and a₄ are the data that needs integrity protection and encryption in the target data, and a₅ is the metadata of the target data, the data carried in the unprotected area may be a₁, the data carried in the integrity protection unencrypted area may be a₂, and the data carried in the integrity protection encryption area may be a₃ and a₄; or the data carried in the unprotected area may be a₁, the data carried in the integrity protection unencrypted area may be a₂, and the data carried in the integrity protection encryption area may be a₁, a₂, a₃, and a₄; or the data carried in the unencrypted area may be a₅, and the data carried in the integrity protection encryption area may be a₁, a₂, a₃, and a₄.

Specifically, when step 201 is specifically implemented in the third manner, a manner 1 or a manner 2 may be further used for implementation.

In the manner 1, when data of each attribute in data of three different attributes included in the target data is continuously stored in the target data, and a sequence of the data of three attributes in the target data is the same as a sequence of three areas in the target message, the first device separately adds the data of three attributes to a corresponding area in the three areas, so that the second device sequentially combines, based on the sequence of the three areas in the received target message, the data carried in the three areas to obtain the target data.

Specifically, the data carried in the target message may be shown in FIG. 4 if the data included in the target data is sequentially a₁, a₂, a₃, a₄, a₅, and a₆, and if a₁ and a₂ are the data that needs integrity protection and needs to be encrypted in the target data, a₃ and a₄ are the data that needs integrity protection but does not need to be encrypted in the target data, a₅ and a₆ are the data that does not need integrity protection and does not need to be encrypted in the target data, and the sequence of the three areas in the target message is the integrity protection encryption area, the integrity protection unencrypted area, and the unprotected area.

In the manner 2, the first device divides the data in the target data into N pieces of data, where each piece of data has one attribute and one unique number, and the first device separately adds the N pieces of data to the corresponding area in the three areas based on the attributes of the N pieces of data, so that the second device combines the N pieces of data based on the numbers of the N pieces of data, to obtain the target data, and N is an integer greater than or equal to 3.

Specifically, if the data included in the target data is sequentially a₁, a₂, a₃, a₄, a₅, and a₆, numbers of a₁, a₂, a₃, a₄, a₅, and a₆ are 1, 2, 3, 4, 5 and 6. The data carried in the target message may be shown in FIG. 5 if a₁ and a₃ are the data that needs integrity protection and needs to be encrypted in the target data, a₂ and a₅ are the data that needs integrity protection but does not need to be encrypted in the target data, a₄ and a₆ are the data that does not need integrity protection and does not need to be encrypted in the target data, and the sequence of the three areas in the target message is the integrity protection encryption area, the integrity protection unencrypted area, and the unprotected area.

In the manner 1 and the manner 2, the data of three attributes is respectively the data that needs integrity protection and needs to be encrypted, the data that needs integrity protection but does not need to be encrypted, and the data that does not need integrity protection and does not need to be encrypted, and the three areas are respectively the unprotected area, the integrity protection unencrypted area, and the integrity protection encryption area.

It should be noted that data of some attributes in the data of three different attributes included in the target data may be empty.

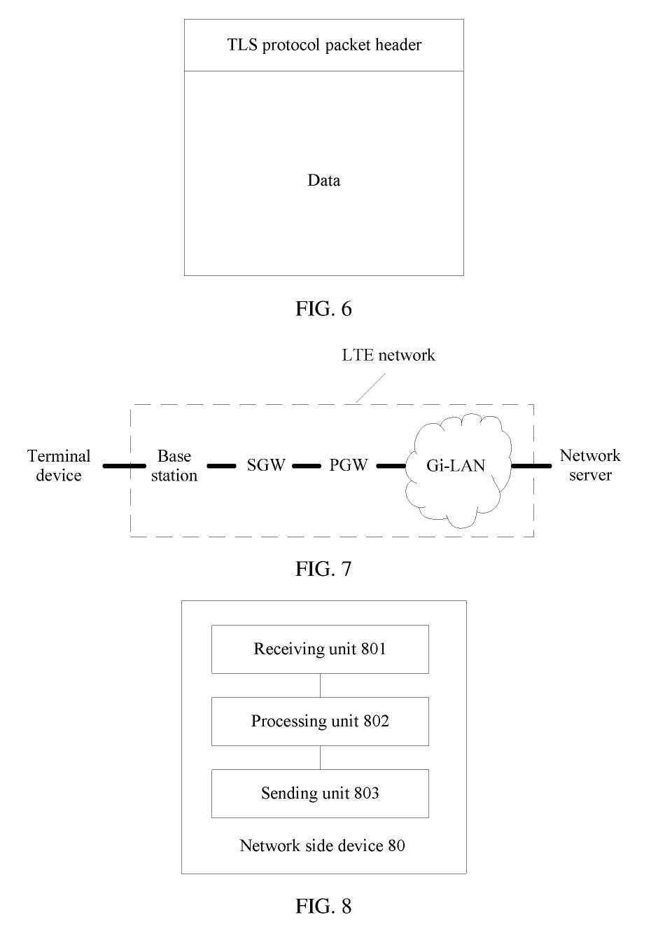

For example, in the current system, when the TLS protocol is used between both communication parties, the TLS Record Protocol is used to carry content on which security protection is performed. The TLS Record Protocol includes a TLS protocol packet header and the content on which security protection is performed, specifically, as shown in FIG. 6 (a data area in FIG. 6 is the content on which security protection is performed). When the method provided in this embodiment of the present application is used, a TLS record layer may be divided into three areas: the unprotected area, the integrity protection unencrypted area, and the integrity protection encryption area, to transmit data from a TLS upper layer (to be specific, data carried in TLS, for example, if an HTTP message is transmitted by using the TLS, upper-layer data herein is data of an HTTP layer). Specifically, the TLS protocol packet header in FIG. 6 and the data that does not need integrity protection and does not need to be encrypted in the content on which security protection is performed may be carried in the unprotected area, the data that needs integrity protection but does not need to be encrypted in the content on which security protection is performed may be carried in the integrity protection unencrypted area, and the data that needs security protection and needs to be encrypted in the content on which security protection is performed may be carried in the integrity protection encryption area. Specifically, there is no need to modify an existing TLS record layer structure. Only an extended cipher type (security protection type) needs to be defined: a generic partial cipher (partial security protection). Each cipher type represents a specific type of security protection, and the generic partial cipher internally includes three areas: the unprotected area, the integrity protection unencrypted area, and the integrity protection encryption area.

202. The first device sends the target message to a network side device.

The network side device may specifically include a network service performance optimization device and/or a DPI device, and the like in an operator network. An LTE network is used as an example. As shown in FIG. 7, the LTE network includes a base station, a serving gateway (SGW), a packet data gateway (PGW), a Gi-LAN, and the like, and various network service processing entities may be deployed in the Gi-LAN of the LTE network. The network service performance optimization device in this embodiment of the present application may be a network service processing entity deployed in the Gi-LAN. When the network side device is the DPI device, the DPI device may perform an operation such as service type detection using the data carried in the unencrypted area in the target message.

203. The network side device receives the target message sent by the first device.

204. The network side device performs service processing on the target message based on data carried in an unencrypted area in the target message.

Because the data carried in the unencrypted area is not encrypted, the network side device may obtain the data carried in the unencrypted area and perform the service processing based on the obtained data carried in the unencrypted area.

Specifically, in a specific implementation, step 204 includes: obtaining, by the network side device, the data carried in the unencrypted area, and performing, by the network side device, service optimization on the target message based on the data carried in the unencrypted area.

For example, when the network side device includes the network service performance optimization device and the DPI device, if the data carried in the unencrypted area includes the HTTP protocol packet header, the DPI device may determine a service type of the target message based on the HTTP protocol packet header, and the network service performance optimization device may perform the service optimization based on the service type of the target message. For example, the network service performance optimization device may allocate an appropriate network resource to the target message based on the service type of the target message. When the target data carried in the target message is video data, the network service performance optimization device may transcode the target message based on a network status.

205. The network side device sends, to the second device, a target message obtained after the service processing.

Optionally, after step 204, the method further includes: adding, by the network side device to the unprotected area in the target message, a processing result of performing the service processing on the target message based on the data carried in the unencrypted area in the target message. In this case, step 205 includes: sending, by the network side device to the second device, the target message that carries the processing result.

Specifically, the adding, by the network side device, a processing result to the unprotected area in the target message may be: changing, by the network side device, the data in the unprotected area to the processing result, or adding, by the network side device, the processing result to the unprotected area.

For example, the processing result may be specifically header enhancement, charging redirection, or the like.

206. The second device receives the target message sent by the network side device.

Specifically, after receiving the target message sent by the network side device, the second device first performs security verification on data in the integrity protection unencrypted area and the integrity protection encryption area based on the security parameter negotiated with the first device. For the data in the unprotected area, the second device may accept or discard the data, or may determine whether to accept or discard the data after performing verification in a preset manner.

Specifically, when the first device performs step 201 in the manner 1, the second device sequentially combines, based on the sequence of the three areas in the received target message, the data carried in the three areas to obtain the target data.

For example, based on the example described in FIG. 4, the second device sequentially combines the data in the integrity protection encryption area, the integrity protection unencrypted area, and the unprotected area in the target message to obtain the target data.

When the first device performs step 201 in the manner 2, the second device combines the N pieces of data based on the numbers of the N pieces of data, to obtain the target data.

For example, based on the example described in FIG. 5, the second device sequentially combines data whose numbers are 1, 2, 3, 4, 5, and 6 in the target message to obtain the target data.

According to the method provided in this embodiment of the present application, the first device may add the data that does not need to be encrypted to the unencrypted area in the target message and send the data that does not need to be encrypted to the network side device, and the network side device may obtain the data in the unencrypted area, and perform the service processing on the target message based on the data in the unencrypted area, so as to prevent the network side device deployed in the operator network from being inoperative.

An embodiment of the present application further provides a network side device 80. As shown in FIG. 8, the network side device 80 includes a receiving unit 801, configured to receive a target message sent by a first device, where the target message is used to carry target data, the target data is data transmitted by the first device to a second device, the target message includes an unencrypted area and an integrity protection encryption area, the unencrypted area is used to carry data that does not need to be encrypted, the data that does not need to be encrypted is data in the target data or data related to the target data, the integrity protection encryption area is used to carry data that needs integrity protection and encryption, and the data that needs integrity protection and encryption is data in the target data. The network side device 80 also includes a processing unit 802, configured to perform service processing on the target message based on the data carried in the unencrypted area in the target message. The network side device 80 also includes a sending unit 803, configured to send, to the second device, a target message obtained after the service processing.

Optionally, the unencrypted area includes an unprotected area and an integrity protection unencrypted area, the unprotected area is used to carry data that does not need integrity protection and does not need to be encrypted, and the integrity protection unencrypted area is used to carry data that needs integrity protection but does not need to be encrypted.

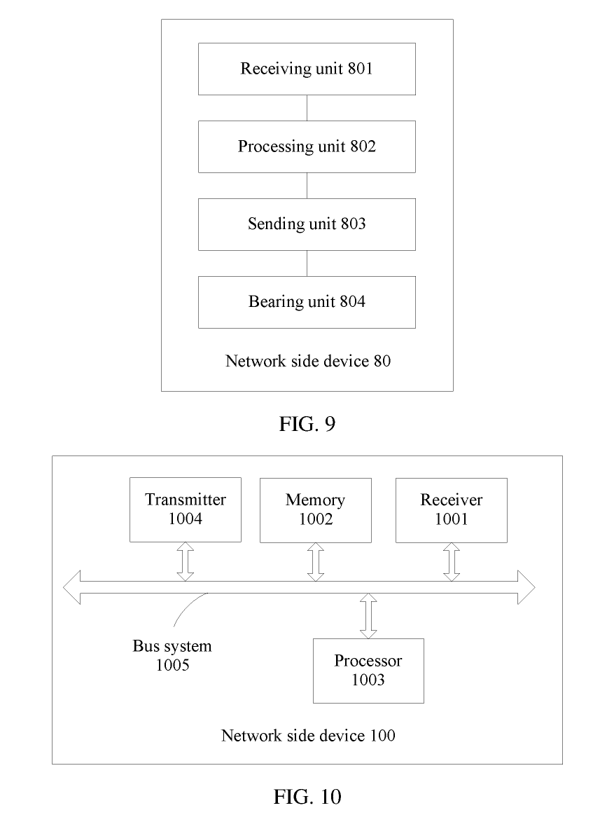

Optionally, as shown in FIG. 9, the network side device 80 further includes: a bearing unit 804, configured to add, to the unprotected area in the target message, a processing result of performing the service processing on the target message based on the data carried in the unencrypted area in the target message. The sending unit 803 is specifically configured to send, to the second device, the target message that carries the processing result.

Optionally, the processing unit 802 is specifically configured to: obtain the data carried in the unencrypted area; and perform service optimization on the target message based on the data carried in the unencrypted area.

Optionally, the target data is carried in the integrity protection encryption area, the data that needs integrity protection but does not need to be encrypted in the target data is carried in the integrity protection unencrypted area, and the data that does not need integrity protection and does not need to be encrypted in the target data is carried in the unprotected area; or the target data is carried in the integrity protection encryption area, and metadata of the target data is carried in the unencrypted area; or the data that needs integrity protection and needs to be encrypted in the target data is carried in the integrity protection encryption area, the data that needs integrity protection but does not need to be encrypted in the target data is carried in the integrity protection unencrypted area, and the data that does not need integrity protection and does not need to be encrypted in the target data is carried in the unprotected area.

The network side device provided in this embodiment of the present application obtains the data in the unencrypted area in the target message based on the received target message sent by the first device, and performs the service processing on the target message based on the data in the unencrypted area, so as to prevent the network side device deployed in an operator network from being inoperative.

In terms of hardware implementation, each unit in the network side device 80 may be embedded in or independent of a processor of the network side device 80 in a form of hardware, or may be stored in a memory of the network side device 80 in a form of software, so that the processor invokes and performs an operation corresponding to each unit. The processor may be a central processing unit (CPU), an application-specific integrated circuit (ASIC), or one or more integrated circuits configured to implement this embodiment of the present application.

An embodiment of the present application further provides a network side device 100, as shown in FIG. 10, including a receiver 1001, a memory 1002, a processor 1003, and a transmitter 1004.

The receiver 1001, the memory 1002, the processor 1003, and the transmitter 1004 are coupled together by using a bus system 1005. The memory 1002 may include a random access memory, and may further include a non-volatile memory, such as at least one disk memory. The bus system 1005 may be an industry standard architecture (ISA) bus, a peripheral component interconnect (PCI) bus, an extended industry standard architecture (EISA) bus, or the like. The bus system 1005 may be classified into an address bus, a data bus, a control bus, and the like. For ease of representation, only one thick line is used in FIG. 10, but it does not indicate that there is only one bus or one type of bus.

The receiver 1001 is configured to receive a target message sent by a first device, where the target message is used to carry target data, the target data is data transmitted by the first device to a second device, the target message includes an unencrypted area and an integrity protection encryption area, the unencrypted area is used to carry data that does not need to be encrypted, the data that does not need to be encrypted is data in the target data or data related to the target data, the integrity protection encryption area is used to carry data that needs integrity protection and encryption, and the data that needs integrity protection and encryption is data in the target data.

The memory 1002 is configured to store a group of code, and the processor 1003 performs the following action based on the group of code: performing service processing on the target message based on the data carried in the unencrypted area in the target message.

The transmitter 1004 is configured to send, to the second device, a target message obtained after the service processing.

Optionally, the unencrypted area includes an unprotected area and an integrity protection unencrypted area, the unprotected area is used to carry data that does not need integrity protection and does not need to be encrypted, and the integrity protection unencrypted area is used to carry data that needs integrity protection but does not need to be encrypted.

Optionally, the processor 1003 is further configured to: add, to the unprotected area in the target message, a processing result of performing the service processing on the target message based on the data carried in the unencrypted area in the target message. The transmitter 1004 is specifically configured to send, to the second device, the target message that carries the processing result.

Optionally, the processor 1003 is specifically configured to: obtain the data carried in the unencrypted area; and perform service optimization on the target message based on the data carried in the unencrypted area.

Optionally, the target data is carried in the integrity protection encryption area, the data that needs integrity protection but does not need to be encrypted in the target data is carried in the integrity protection unencrypted area, and the data that does not need integrity protection and does not need to be encrypted in the target data is carried in the unprotected area; or the target data is carried in the integrity protection encryption area, and metadata of the target data is carried in the unencrypted area; or the data that needs integrity protection and needs to be encrypted in the target data is carried in the integrity protection encryption area, the data that needs integrity protection but does not need to be encrypted in the target data is carried in the integrity protection unencrypted area, and the data that does not need integrity protection and does not need to be encrypted in the target data is carried in the unprotected area.

The network side device provided in this embodiment of the present application obtains the data in the unencrypted area in the target message based on the received target message sent by the first device, and performs the service processing on the target message based on the data in the unencrypted area, so as to prevent the network side device deployed in an operator network from being inoperative.

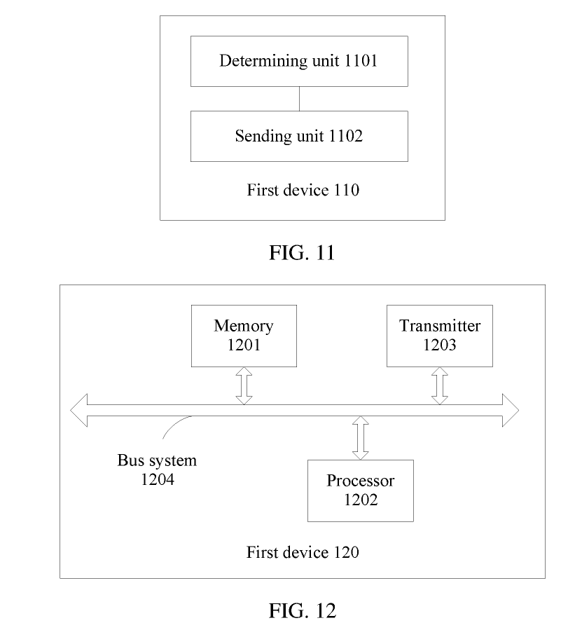

An embodiment of the present application further provides a first device 110. As shown in FIG. 11, the first device no includes: a determining unit 1101, configured to determine a target message, where the target message is used to carry target data, the target data is data transmitted by the first device to a second device, the target message includes an unencrypted area and an integrity protection encryption area, the unencrypted area is used to carry data that does not need to be encrypted, the data that does not need to be encrypted is data in the target data or data related to the target data, the integrity protection encryption area is used to carry data that needs integrity protection and encryption, and the data that needs integrity protection and encryption is data in the target data; and a sending unit 1102, configured to send the target message to a network side device, so that the network side device performs service processing on the target message based on the data carried in the unencrypted area in the target message.

Optionally, the unencrypted area includes an unprotected area and an integrity protection unencrypted area, the unprotected area is used to carry data that does not need integrity protection and does not need to be encrypted, and the integrity protection unencrypted area is used to carry data that needs integrity protection but does not need to be encrypted.

Optionally, the determining unit 1101 is specifically configured to: add the target data to the integrity protection encryption area, add, to the integrity protection unencrypted area, the data that needs integrity protection but does not need to be encrypted in the target data, and add, to the unprotected area, the data that does not need integrity protection and does not need to be encrypted in the target data; or add the target data to the integrity protection encryption area, and add metadata of the target data to the unencrypted area; or add, to the integrity protection encryption area, the data that needs integrity protection and needs to be encrypted in the target data, add, to the integrity protection unencrypted area, the data that needs integrity protection but does not need to be encrypted in the target data, and add, to the unprotected area, the data that does not need integrity protection and does not need to be encrypted in the target data.

Optionally, the determining unit 1101 is specifically configured to: when data of each attribute in data of three different attributes included in the target data is continuously stored in the target data, and a sequence of the data of three attributes in the target data is the same as a sequence of three areas in the target message, separately add the data of three attributes to a corresponding area in the three areas, so that the second device sequentially combines, based on the sequence of the three areas in the received target message, the data carried in the three areas to obtain the target data; or divide the data in the target data into N pieces of data, where each piece of data has one attribute and one unique number, and the first device separately adds the N pieces of data to the corresponding area in the three areas based on the attributes of the N pieces of data, so that the second device combines the N pieces of data based on the numbers of the N pieces of data, to obtain the target data, and N is an integer greater than or equal to 3, where the data of three attributes is respectively the data that needs integrity protection and needs to be encrypted, the data that needs integrity protection but does not need to be encrypted, and the data that does not need integrity protection and does not need to be encrypted, and the three areas are respectively the unprotected area, the integrity protection unencrypted area, and the integrity protection encryption area.

The first device provided in this embodiment of the present application may add the data that does not need to be encrypted to the unencrypted area in the target message and send the data that does not need to be encrypted to the network side device, and the network side device may obtain the data in the unencrypted area, and perform the service processing on the target message based on the data in the unencrypted area, so as to prevent the network side device deployed in an operator network from being inoperative.

In terms of hardware implementation, each unit in the first device no may be embedded in or independent of a processor of the first device no in a form of hardware, or may be stored in a memory of the first device no in a form of software, so that the processor invokes and performs an operation corresponding to each unit. The processor may be a CPU, an ASIC, or one or more integrated circuits configured to implement this embodiment of the present application.

An embodiment of the present application further provides a first device 120. As shown in FIG. 12, the first device 120 includes a memory 1201, a processor 1202, and a transmitter 1203.

The memory 1201, the processor 1202, and the transmitter 1203 are coupled together by using a bus system 1204. The memory 1202 may include a random access memory, and may further include a non-volatile memory, such as at least one disk memory. The bus system 1204 may be an ISA bus, a PCI bus, an EISA bus, or the like. The bus system 1204 may be classified into an address bus, a data bus, a control bus, and the like. For ease of representation, only one thick line is used in FIG. 12, but it does not indicate that there is only one bus or one type of bus.

The memory 1201 is configured to store a group of code, and the processor 1202 performs the following action based on the group of code: determining a target message, where the target message is used to carry target data, the target data is data transmitted by the first device to a second device, the target message includes an unencrypted area and an integrity protection encryption area, the unencrypted area is used to carry data that does not need to be encrypted, the data that does not need to be encrypted is data in the target data or data related to the target data, the integrity protection encryption area is used to carry data that needs integrity protection and encryption, and the data that needs integrity protection and encryption is data in the target data.

The transmitter 1203 is configured to send the target message to a network side device, so that the network side device performs service processing on the target message based on the data carried in the unencrypted area in the target message.

Optionally, the unencrypted area includes an unprotected area and an integrity protection unencrypted area, the unprotected area is used to carry data that does not need integrity protection and does not need to be encrypted, and the integrity protection unencrypted area is used to carry data that needs integrity protection but does not need to be encrypted.

Optionally, the processor 1202 is specifically configured to: add the target data to the integrity protection encryption area, add, to the integrity protection unencrypted area, the data that needs integrity protection but does not need to be encrypted in the target data, and add, to the unprotected area, the data that does not need integrity protection and does not need to be encrypted in the target data; or add the target data to the integrity protection encryption area, and add metadata of the target data to the unencrypted area; or add, to the integrity protection encryption area, the data that needs integrity protection and needs to be encrypted in the target data, add, to the integrity protection unencrypted area, the data that needs integrity protection but does not need to be encrypted in the target data, and add, to the unprotected area, the data that does not need integrity protection and does not need to be encrypted in the target data.

Optionally, the processor 1202 is specifically configured to: when data of each attribute in data of three different attributes included in the target data is continuously stored in the target data, and a sequence of the data of three attributes in the target data is the same as a sequence of three areas in the target message, separately add the data of three attributes to a corresponding area in the three areas, so that the second device sequentially combines, based on the sequence of the three areas in the received target message, the data carried in the three areas to obtain the target data; or divide the data in the target data into N pieces of data, where each piece of data has one attribute and one unique number, and the first device separately adds the N pieces of data to the corresponding area in the three areas based on the attributes of the N pieces of data, so that the second device combines the N pieces of data based on the numbers of the N pieces of data, to obtain the target data, and N is an integer greater than or equal to 3, where the data of three attributes is respectively the data that needs integrity protection and needs to be encrypted, the data that needs integrity protection but does not need to be encrypted, and the data that does not need integrity protection and does not need to be encrypted, and the three areas are respectively the unprotected area, the integrity protection unencrypted area, and the integrity protection encryption area.

The first device provided in this embodiment of the present application may add the data that does not need to be encrypted to the unencrypted area in the target message and send the data that does not need to be encrypted to the network side device, and the network side device may obtain the data in the unencrypted area, and perform the service processing on the target message based on the data in the unencrypted area, so as to prevent the network side device deployed in an operator network from being inoperative.

In the several embodiments provided in this application, it should be understood that the disclosed apparatus and method may be implemented in other manners. For example, the described apparatus embodiment is merely an example. For example, the module division is merely logical function division and may be other division in actual implementation. For example, a plurality of modules or components may be combined or integrated into another system, or some features may be ignored or not performed.

The modules described as separate parts may or may not be physically separate, and parts displayed as modules may or may not be physical modules, may be located in one position, or may be distributed on a plurality of network units. Some or all of the units may be selected according to actual needs to achieve the objectives of the solutions of the embodiments.

In addition, functional modules in the embodiments of the present application may be integrated into one processing module, or two or more modules are integrated into one module. The integrated module may be implemented in a form of hardware, or may be implemented in a form of hardware in addition to a software functional module.

When the foregoing integrated module is implemented in a form of a software functional module, the integrated unit may be stored in a computer-readable storage medium. The software functional module is stored in a storage medium and includes several instructions for instructing a computer device (which may be a personal computer, a server, or a network device) to perform some of the steps of the methods described in the embodiments of the present application. The foregoing storage medium includes: any medium that can store program code, such as a USB flash drive, a removable hard disk, a read-only memory (ROM), a random access memory (RAM), a magnetic disk, or an optical disc.

What is claimed is:

1. A data security protection method, comprising:
receiving, by a network side device, a target message sent by a first device, wherein the target message is used to carry target data, the target data is data transmitted by the first device to a second device, the target message comprises an unencrypted area and an integrity protection encryption area, the unencrypted area is used to carry data that does not need to be encrypted, the data that does not need to be encrypted is data in the target data or data related to the target data, the integrity protection encryption area is used to carry data that needs integrity protection and encryption, and the data that needs integrity protection and encryption is data in the target data;
performing, by the network side device, service processing on the target message based on the data carried in the unencrypted area in the target message; and
sending, by the network side device to the second device, a target message obtained after the service processing.

2. The method according to claim 1, wherein the unencrypted area comprises an unprotected area and an integrity protection unencrypted area, the unprotected area is used to carry data that does not need integrity protection and does not need to be encrypted, and the integrity protection unencrypted area is used to carry data that needs integrity protection but does not need to be encrypted.

3. The method according to claim 2, wherein after the performing, by the network side device, service processing on the target message based on the data carried in the unencrypted area in the target message, the method further comprises:
adding, by the network side device to the unprotected area in the target message, a processing result of performing the service processing on the target message based on the data carried in the unencrypted area in the target message; and
the sending, by the network side device to the second device, a target message obtained after the service processing comprises:
sending, by the network side device to the second device, the target message that carries the processing result.

4. The method according to claim 2, wherein the performing, by the network side device, service processing on the target message based on the data carried in the unencrypted area in the target message comprises:
obtaining, by the network side device, the data carried in the unencrypted area; and
performing, by the network side device, service optimization on the target message based on the data carried in the unencrypted area.

5. The method according to claim 2, wherein the target data is carried in the integrity protection encryption area, the data that needs integrity protection but does not need to be encrypted in the target data is carried in the integrity protection unencrypted area, and the data that does not need integrity protection and does not need to be encrypted in the target data is carried in the unprotected area; or the target data is carried in the integrity protection encryption area, and metadata of the target data is carried in the unencrypted area; or the data that needs integrity protection and needs to be encrypted in the target data is carried in the integrity protection encryption area, the data that needs integrity protection but does not need to be encrypted in the target data is carried in the integrity protection unencrypted area, and the data that does not need integrity protection and does not need to be encrypted in the target data is carried in the unprotected area.

6. A network side device, comprising a receiver, a memory, a processor, and a transmitter, wherein
the receiver is configured to receive a target message sent by a first device, wherein the target message is used to carry target data, the target data is data transmitted by the first device to a second device, the target message comprises an unencrypted area and an integrity protection encryption area, the unencrypted area is used to carry data that does not need to be encrypted, the data that does not need to be encrypted is data in the target data or data related to the target data, the integrity protection encryption area is used to carry data that needs integrity protection and encryption, and the data that needs integrity protection and encryption is data in the target data;
the memory is configured to store a group of code, and the processor performs the following action based on the group of code: performing service processing on the target message based on the data carried in the unencrypted area in the target message; and
the transmitter is configured to send, to the second device, a target message obtained after the service processing.

7. The network side device according to claim 6, wherein the unencrypted area comprises an unprotected area and an integrity protection unencrypted area, the unprotected area is used to carry data that does not need integrity protection and does not need to be encrypted, and the integrity protection unencrypted area is used to carry data that needs integrity protection but does not need to be encrypted.

8. The network side device according to claim 7, wherein the processor is further configured to:
add, to the unprotected area in the target message, a processing result of performing the service processing on the target message based on the data carried in the unencrypted area in the target message; and
the transmitter is specifically configured to send, to the second device, the target message that carries the processing result.

9. The network side device according to claim 7, wherein the processor is specifically configured to:
obtain the data carried in the unencrypted area; and
perform service optimization on the target message based on the data carried in the unencrypted area.

10. The network side device according to claim 7, wherein the target data is carried in the integrity protection encryption area, the data that needs integrity protection but does not need to be encrypted in the target data is carried in the integrity protection unencrypted area, and the data that does not need integrity protection and does not need to be encrypted in the target data is carried in the unprotected area; or the target data is carried in the integrity protection encryption area, and metadata of the target data is carried in the unencrypted area; or the data that needs integrity protection and needs to be encrypted in the target data is carried in the integrity protection encryption area, the data that needs integrity protection but does not need to be encrypted in the target data is carried in the integrity protection unencrypted area, and the data that does not need integrity protection and does not need to be encrypted in the target data is carried in the unprotected area.

11. A first device, comprising a memory, a processor, and a transmitter, wherein the memory is configured to store a group of code, and the processor performs the following action based on the group of code:
determining a target message, wherein the target message is used to carry target data, the target data is data transmitted by the first device to a second device, the target message comprises an unencrypted area and an integrity protection encryption area, the unencrypted area is used to carry data that does not need to be encrypted, the data that does not need to be encrypted is data in the target data or data related to the target data, the integrity protection encryption area is used to carry data that needs integrity protection and encryption, and the data that needs integrity protection and encryption is data in the target data; and
the transmitter is configured to send the target message to a network side device, so that the network side device performs service processing on the target message based on the data carried in the unencrypted area in the target message.

12. The first device according to claim 11, wherein the unencrypted area comprises an unprotected area and an integrity protection unencrypted area, the unprotected area is used to carry data that does not need integrity protection and does not need to be encrypted, and the integrity protection unencrypted area is used to carry data that needs integrity protection but does not need to be encrypted.

13. The first device according to claim 12, wherein the processor is specifically configured to:
add the target data to the integrity protection encryption area, add, to the integrity protection unencrypted area, the data that needs integrity protection but does not need to be encrypted in the target data, and add, to the unprotected area, the data that does not need integrity protection and does not need to be encrypted in the target data; or
add the target data to the integrity protection encryption area, and add metadata of the target data to the unencrypted area; or
add, to the integrity protection encryption area, the data that needs integrity protection and needs to be encrypted in the target data, add, to the integrity protection unencrypted area, the data that needs integrity protection but does not need to be encrypted in the target data, and add, to the unprotected area, the data that does not need integrity protection and does not need to be encrypted in the target data.

14. The first device according to claim 13, wherein the processor is specifically configured to:
when data of each attribute in data of three different attributes comprised in the target data is continuously stored in the target data, and a sequence of the data of three attributes in the target data is the same as a sequence of three areas in the target message, separately add the data of three attributes to a corresponding area in the three areas, so that the second device sequentially combines, based on the sequence of the three areas in the received target message, the data carried in the three areas to obtain the target data; or
divide the data in the target data into N pieces of data, wherein each piece of data has one attribute and one unique number, and the first device separately adds the N pieces of data to the corresponding area in the three areas based on the attributes of the N pieces of data, so that the second device combines the N pieces of data based on the numbers of the N pieces of data, to obtain the target data, and N is an integer greater than or equal to 3, wherein
the data of three attributes is respectively the data that needs integrity protection and needs to be encrypted, the data that needs integrity protection but does not need to be encrypted, and the data that does not need integrity protection and does not need to be encrypted, and the three areas are respectively the unprotected area, the integrity protection unencrypted area, and the integrity protection encryption area.
